(19) United States
(12) Patent Application Publication
(10) Pub. No.: US 2025/0015459 A1
(43) Pub. Date: Jan. 9, 2025

(54) TERMINAL FOR ELECTRICAL ENERGY STORAGE DEVICE, AND MANUFACTURING METHOD FOR ELECTRICAL ENERGY STORAGE DEVICE INCLUDING THE SAME

(71) Applicant: Prime Planet Energy & Solutions, Inc., Tokyo (JP)

(72) Inventors: Kohei YAMADA, Kobe-shi (JP); Ryoichi WAKIMOTO, Kobe-shi (JP)

(21) Appl. No.: 18/757,495

(22) Filed: Jun. 28, 2024

(30) Foreign Application Priority Data
Jul. 7, 2023 (JP) 2023-112282

(51) Int. Cl. H01M 50/553; H01G 11/74; H01G 11/86; H01M 50/533; H01M 50/562; H01M 50/564; H01M 50/566; H01M 50/567

(52) U.S. Cl. CPC H01M 50/553; H01G 11/74; H01G 11/86; H01M 50/533; H01M 50/562; H01M 50/564; H01M 50/566; H01M 50/567

(57) ABSTRACT

The present disclosure provides a terminal including a first conductive member that is formed of a first metal and includes a concave part, a second conductive member that is formed of a second metal and includes a part disposed in the concave part, and an ultrasonic bonding part where the first conductive member and the second conductive member are bonded to each other with ultrasonic waves. The first conductive member includes a rib that is provided on an outer peripheral side relative to the ultrasonic bonding part and that protrudes from a second surface of the first conductive member.

### CROSS REFERENCE TO RELATED APPLICATION

This application claims the benefit of priority to Japanese Patent Application No. 2023-112282 filed on Jul. 7, 2023. The entire contents of this application are hereby incorporated herein by reference.

### BACKGROUND OF THE DISCLOSURE

### 1. Field

The present disclosure relates to a terminal for an electrical energy storage device, and a manufacturing method for the electrical energy storage device including the same.

### 2. Background

Conventionally, a terminal formed by bonding conductive members made of different kinds of metals (a first conductive member and a second conductive member) has been known. For example, Japanese Patent Application Publication No. 2022-049729 discloses a manufacturing method for a terminal, including a fastening step of forming a fastening part by mechanically fixing a first conductive member and a second conductive member, and a metal bonding step of forming a metal bonding part by metal-bonding the first conductive member and the second conductive member, and a manufacturing method for an electrical energy storage device, including a caulking step of fixing the terminal to a battery case ad a current collecting member by a caulking process.

### SUMMARY

For example, in the mechanical bonding step such as a fastening step or a caulking step, burden may be applied on the conductive member or the metal boning part. This may lead to deformation of the conductive member or damage of the metal bonding part, so that the connection state between the first conductive member and the second conductive member may become unstable. In particular, in the case of forming an ultrasonic bonding part by bonding the first conductive member and the second conductive member with ultrasonic waves in the metal bonding step, it is preferable to perform the ultrasonic bonding before the caulking step; accordingly, such a tendency has been remarkable.

The present disclosure has been made in view of the above circumstances, and an object is to provide a terminal for an electrical energy storage device, in which an ultrasonic bonding part is included and the reliability of a connection part between a first conductive member and a second conductive member is high, and a manufacturing method for the electrical energy storage device including the terminal.

A terminal for an electrical energy storage device according to the present disclosure includes a first conductive member that is formed of a first metal and includes a concave part on a first surface, a second conductive member that is formed of a second metal, which is different from the first metal, and includes a part disposed in the concave part, and an ultrasonic bonding part where the first conductive member and the second conductive member are bonded to each other with ultrasonic waves, in which the first conductive member includes a rib that is provided on an outer peripheral side relative to the ultrasonic bonding part and that protrudes from a second surface of the first conductive member that is on a side opposite to the first surface.

With the aforementioned structure, the terminal in which reliability of a connection part between the first conductive member and the second conductive member is high is obtained.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view illustrating schematically an electrical energy storage device according to an embodiment;

FIG. 2 is a schematic longitudinal cross-sectional view taken along line II-II in FIG. 1;

FIG. 3 is a partial enlarged cross-sectional view illustrating schematically a vicinity of a negative electrode terminal;

FIG. 4 is a top view illustrating schematically the negative electrode terminal according to an embodiment;

FIG. 5 is a schematic longitudinal cross-sectional view taken along line V-V in FIG. 4;

FIG. 6 is a longitudinal cross-sectional view illustrating schematically the connection between the negative electrode terminal and an external conductive member;

FIG. 7 is a perspective view illustrating schematically an electrical energy storage module according to an embodiment;

FIG. 8 is a longitudinal cross-sectional view illustrating schematically one example of a caulking step;

FIG. 9 is a view corresponding to FIG. 5 according to a first modification; and

FIG. 10 is a view corresponding to FIG. 5 according to a second modification.

### DETAILED DESCRIPTION OF THE PREFERRED EMBODIMENTS

Preferred embodiments of the art disclosed herein will be explained next with reference to the accompanying drawings. Matters that are other than matters particularly mentioned in the present specification and that are necessary for the implementation of the present disclosure (for example, the general configuration and manufacturing process of an electrical energy storage device that do not characterize the present disclosure) can be grasped as design matters of those skilled in the art based on the prior art in the relevant field. The art disclosed herein can be realized on the basis of the disclosure of the present specification and common technical knowledge in the relevant field.

### <Electrical Energy Storage Device 100>

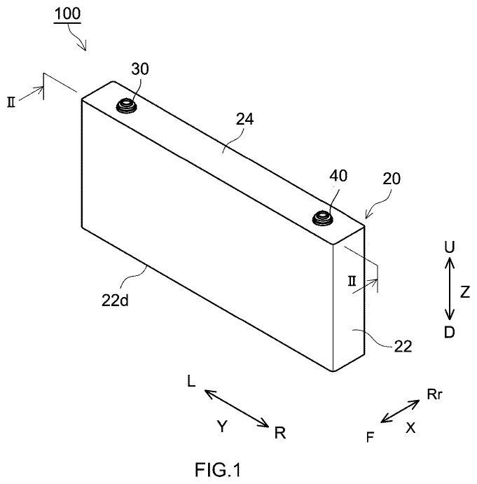

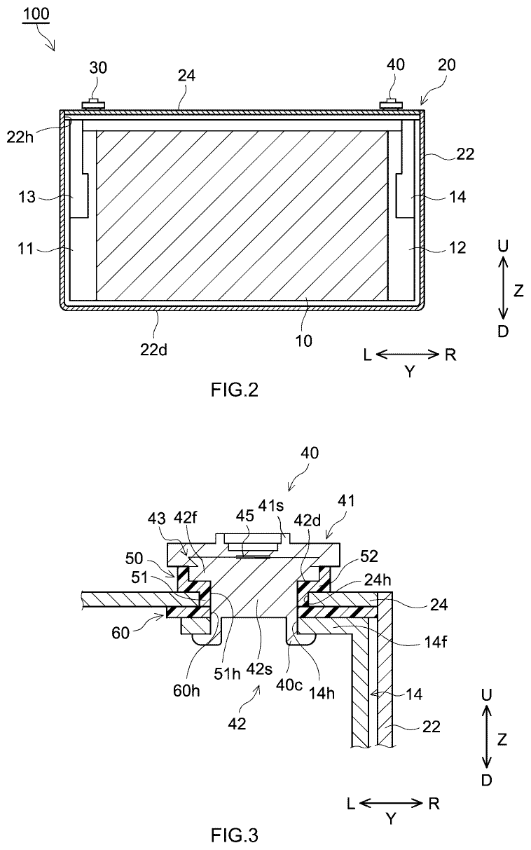

FIG. 1 is a perspective view of an electrical energy storage device 100. FIG. 2 is a schematic longitudinal cross-sectional view taken along line II-II in FIG. 1. In the explanation below, the reference signs L, R, U, and D in the drawings represent respectively left, right, up, and down, and the reference signs X, Y and Z in the drawings represent respectively a short side direction of the electrical energy storage device 100, a long side direction orthogonal to the short side direction, and an up-down direction. However, the foregoing are merely directions for convenience of explanation, and do not limit in any way the manner in which the electrical energy storage device 100 is installed.

Note that in the present specification, the term “electrical energy storage device” refers to general devices that are capable of being charged and discharged repeatedly, and corresponds to a concept encompassing storage batteries such as lithium ion secondary batteries and nickel-hydrogen batteries and capacitors such as lithium ion capacitors and electrical double-layer capacitors.

As illustrated in FIG. 2, the electrical energy storage device 100 includes an electrode body 10, a positive electrode current collecting member 13, a negative electrode current collecting member 14, a battery case 20, a positive electrode terminal 30, and a negative electrode terminal 40. The electrical energy storage device 100 is characterized by including the positive electrode terminal 30 and/or negative electrode terminal 40 disclosed herein; the other features of the electrical energy storage device 100 may be similar to conventional ones. The electrical energy storage device 100 is preferably a secondary battery, and more preferably a nonaqueous electrolyte secondary battery. The electrical energy storage device 100 is a lithium ion secondary battery here. Although the illustration is omitted, the electrical energy storage device 100 further includes an electrolyte here. The electrical energy storage device 100 has a configuration in which the electrode body 10 and the electrolyte, which is not illustrated, are accommodated in the battery case 20.

The electrode body 10 may be similar to a conventional one, and is not particularly limited. The electrode body 10 has a positive electrode and a negative electrode (not illustrated). The electrode body 10 is, for example, a wound electrode body with a flat shape in which a positive electrode with a band shape and a negative electrode with a band shape are stacked through a separator with a band shape in an insulated state and wound using a winding axis as a center. In another embodiment, however, the electrode body 10 may be a stack type electrode body formed in such a manner that a square (typically, rectangular) positive electrode and a square (typically, rectangular) negative electrode are stacked in the insulated state. One of the positive electrode and the negative electrode is one example of “first electrode” while the other is one example of “second electrode”. In particular, the negative electrode is preferably the first negative electrode.

The positive electrode includes a positive electrode current collector 11 and a positive electrode mix layer (not illustrated) adhered onto the positive electrode current collector 11. The positive electrode current collector 11 is, for example, formed of a conductive metal such as aluminum, an aluminum alloy, nickel, or stainless steel. The positive electrode mix layer contains a positive electrode active material (for example, a lithium-transition metal complex oxide). The negative electrode includes a negative electrode current collector 12 and a negative electrode mix layer (not illustrated) adhered onto the negative electrode current collector 12. The negative electrode current collector is, for example, formed of a conductive metal such as copper, a copper alloy, nickel, or stainless steel. The negative electrode mix layer contains a negative electrode active material (for example, a carbon material such as graphite).

As illustrated by oblique lines in FIG. 2, in a central part of the electrode body 10 in the long side direction Y, a multilayer part is formed that results from stacking of the positive electrode mix layer and the negative electrode mix layer while being insulated from each other. Meanwhile, at a left end part of the electrode body 10 in the long side direction Y, a part of the positive electrode current collector 11 where the positive electrode mix layer is not formed (positive electrode current collector exposed part) protrudes out of the multilayer part. A positive electrode current collecting member 13 is attached to the positive electrode current collector exposed part. The positive electrode current collecting member 13 may be formed of the same metal material as that of the positive electrode current collector 11, for example, a conductive metal such as aluminum, an aluminum alloy, nickel, or stainless steel. The positive electrode current collecting member 13 electrically connects the positive electrode and the positive electrode terminal 30 inside the battery case 20.

At a right end part of the electrode body 10 in the long side direction Y, a part of the negative electrode current collector 12 where the negative electrode mix layer is not formed (negative electrode current collector exposed part) protrudes out of the multilayer part. A negative electrode current collecting member 14 is attached to the negative electrode current collector exposed part. The negative electrode current collecting member 14 may be formed of the same metal species as that of the negative electrode current collector 12, for example, a conductive metal such as copper, a copper alloy, nickel, or stainless steel. The material (metal species) of the negative electrode current collecting member 14 may be different from that of the positive electrode current collecting member 13. The negative electrode current collecting member 14 electrically connects the negative electrode and the negative electrode terminal 40 inside the battery case 20.

The electrolyte may be similar to a conventional one, and is not particularly limited. The electrolyte is, for example, a nonaqueous liquid electrolyte (nonaqueous electrolyte solution) that contains a nonaqueous solvent and a supporting salt. The nonaqueous solvent includes, for example, a carbonate such as ethylene carbonate, dimethyl carbonate, or ethyl methyl carbonate. The supporting salt is, for example, a fluorine-containing lithium salt such as LiPF₆. The electrolyte may be a solid (solid electrolyte), and may be integrated with the electrode body 10.

The battery case 20 is a housing that accommodates the electrode body 10. The battery case 20 is formed to have a flat bottomed cuboid shape (square shape) here. However, the shape of the battery case 20 is not limited to a square shape, and may be an arbitrary shape such as a cylindrical columnar shape. However, the material of the battery case 20 may be similar to a conventionally used material, and is not particularly limited. The battery case 20 is, for example, formed of a lightweight metal material with suitable thermal conductivity, such as aluminum, an aluminum alloy, or stainless steel. The battery case 20 illustrated in FIG. 2 includes a case main body (exterior body) 22 having an opening part 22h, and a lid body (sealing plate) 24 that covers the opening part 22h. The battery case 20 preferably includes the case main body 22 and the lid body 24. The battery case 20 is integrated through bonding (for example, bonding by welding) of the lid body 24 to a peripheral edge of the opening part 22h of the case main body 22. The battery case 20 is hermetically sealed (closed).

The case main body 22 has a bottom surface 22d. The lid body 24 opposes the bottom surface 22d of the case main body 22. The lid body 24 is attached to the case main body 22 so as to cover the opening part 22h of the case main body 22. The lid body 24 has a substantially rectangular shape here. Note that in the present specification, the term “substantially rectangular shape” encompasses, in addition to a perfect rectangular shape (rectangle), for example, a shape whose corner connecting a long side and a short side of the rectangular shape is rounded, a shape whose corner includes a notch, and the like.

As illustrated in FIG. 1, the positive electrode terminal 30 and the negative electrode terminal 40 protrude out of the battery case 20. The positive electrode terminal 30 and the negative electrode terminal 40 protrude from the same surface (specifically, from the lid body 24) of the battery case 20 here. The positive electrode terminal 30 and the negative electrode terminal 40 may, however, protrude from mutually different surfaces of the battery case 20. The positive electrode terminal 30 and the negative electrode terminal 40 are disposed at opposite end parts of the lid body 24 in the long side direction Y. The positive electrode terminal 30 and/or the negative electrode terminal 40 is one example of the terminal for the electrical energy storage device. It is particularly preferable that the negative electrode terminal 40 be the terminal for the electrical energy storage device.

The positive electrode terminal 30 is electrically connected to the positive electrode of the electrode body 10 through the positive electrode current collecting member 13 inside the battery case 20 as illustrated in FIG. 2. The negative electrode terminal 40 is electrically connected to the negative electrode of the electrode body 10 through the negative electrode current collecting member 14 inside the battery case 20. The positive electrode terminal 30 and the negative electrode terminal 40 are attached to the battery case 20 (specifically, the lid body 24). The positive electrode terminal 30 and the negative electrode terminal 40 are preferably fixed to the battery case 20 (specifically, the lid body 24). The positive electrode terminal 30 and the negative electrode terminal 40 are insulated from the lid body 24 with a gasket 50 (see FIG. 3) and an insulator 60 (see FIG. 3) interposed therebetween.

FIG. 3 is a partial enlarged cross-sectional view illustrating schematically a vicinity of the negative electrode terminal 40. A terminal structure on the side of the negative electrode terminal 40 will be explained in detail below as an example, and the same may apply to a terminal structure on the side of the positive electrode terminal 30. In this case, “negative electrode” can be replaced by “positive electrode” as appropriate in the description below.

As illustrated in FIG. 3, a terminal extraction hole 24h penetrating in the up-down direction Z is provided in the lid body 24. The terminal extraction hole 24h is preferably provided in the battery case 20. The terminal extraction hole 24h is formed preferably in the lid body 24. Although the illustration is omitted, the terminal extraction hole 24h has a circular shape (for example, perfect circle shape) in a plan view here. The terminal extraction hole 24h has an inner diameter of a size that allows insertion of a shaft part 42s before a caulking process of the negative electrode terminal 40, which will be described below. The terminal extraction hole 24h is formed to be smaller than a flange part 42f of the negative electrode terminal 40, which will be described below.

The negative electrode current collecting member 14 is attached to the negative electrode current collector exposed part of the negative electrode current collector 12 to configure a conduction path that electrically connects the negative electrode and the negative electrode terminal 40. The negative electrode current collecting member 14 has a flat plate-shaped part 14f spreading horizontally along an inner surface of the lid body 24. A hole part 14h is formed in the flat plate-shaped part 14f at a position corresponding to the terminal extraction hole 24h. The hole part 14h has an inner diameter of a size that allows insertion of the shaft part 42s before the caulking process of the negative electrode terminal 40, which will be described below. The negative electrode current collecting member 14 is fixed to the lid body 24 together with the negative electrode terminal 40 through the caulking process in a state of being insulated by the insulator 60. The negative electrode current collecting member 14 is one example of the current collecting member.

The gasket 50 is an insulating member disposed between an upper surface (outer surface) of the lid body 24 and the negative electrode terminal 40. An insulating member (for example, gasket 50) is preferably disposed between the battery case 20 (for example, lid body 24) and the negative electrode terminal 40. The gasket 50 has functions of insulating the lid body 24 and the negative electrode terminal 40, and closing the terminal extraction hole 24h here. The gasket 50 is formed of a resin material having electrical insulating properties and being capable of deforming elastically, for example, fluororesin such as perfluoroalkoxy fluororesin (PFA), polyphenylene sulfide resin (PPS), aliphatic polyamide, or the like.

The gasket 50 has a cylindrical part 51 and a base part 52. The cylindrical part 51 prevents direct contact between the lid body 24 and the shaft part 42s of the negative electrode terminal 40. The cylindrical part 51 has a hollow tubular shape. The cylindrical part 51 has a hole part 51h penetrating in the up-down direction Z. The hole part 51h is formed so as to allow insertion of the shaft part 42s of the negative electrode terminal 40 before the caulking process. The cylindrical part 51 is inserted into the terminal extraction hole 24h of the lid body 24. The base part 52 prevents direct contact between the lid body 24 and the flange part 42f of the negative electrode terminal 40, which will be described below. The base part 52 is coupled to an upper end of the cylindrical part 51. The base part 52 extends in the horizontal direction from the upper end of the cylindrical part 51. The base part 52 is formed to have, for example, an annular shape so as to surround the terminal extraction hole 24h of the lid body 24. The base part 52 extends along the upper surface of the lid body 24. The base part 52 is held between a lower surface 42d of the flange part 42f of the negative electrode terminal 40 and the upper surface of the lid body 24, and is compressed in the up-down direction Z as a result of the caulking process.

The insulator 60 is an insulating member disposed between a lower surface (inner surface) of the lid body 24 and the negative electrode current collecting member 14. An insulating member (for example, insulator 60) is preferably disposed between the battery case 20 (for example, lid body 24) and the negative electrode current collecting member 14. The insulator 60 has a flat plate-shaped part spreading horizontally along the inner surface of the lid body 24. A hole part 60h is formed in the flat plate-shaped part at a position corresponding to the terminal extraction hole 24h. The hole part 60h has an inner diameter of a size that allows insertion of the shaft part 42s of the negative electrode terminal 40. The insulator 60 is formed of a resin material that has resistance against the electrolyte that is used, has electrical insulating properties, and is capable of deforming elastically; this resin material is, for example, fluororesin such as perfluoroalkoxy fluororesin (PFA), polyphenylene sulfide resin (PPS), or the like. The flat plate-shaped part of the insulator 60 is held between the lower surface of the lid body 24 and the upper surface of the negative electrode current collecting member 14, and is compressed in the up-down direction Z as a result of the caulking process.

### <Negative Electrode Terminal 40>

As illustrated in FIG. 3, the negative electrode terminal 40 is inserted into the terminal extraction hole 24h and extends from the inside to the outside of the battery case 20. As described below, the negative electrode terminal 40 is configured so that two kinds of conductive members, that is, a first conductive member 41 and a second conductive member 42 are integrated by at least an ultrasonic bonding part 45. It is preferable that the first conductive member 41 and the second conductive member 42 be integrated by a fastening part 43 and the ultrasonic bonding part 45 as described in this embodiment.

As illustrated in FIG. 3, the negative electrode terminal 40 is inserted into the terminal extraction hole 24h of the lid body 24 and the hole part 14h of the negative electrode current collecting member 14, and has a tip end part in the inserting direction (tubular part 42p to be described below) caulked onto the negative electrode current collecting member 14, specifically caulked to a peripheral part surrounding the hole part 14h of the negative electrode current collecting member 14. A caulking part 40c is formed at a lower end part of the negative electrode terminal 40. The negative electrode terminal 40 is fixed, through the caulking process, to the lid body 24, so as to be electrically connected to the negative electrode current collecting member 14. The caulking part 40c has a tubular shape here. The shape of the caulking part 40c, however, is not limited to the tubular shape and may have an optional shape such as a pillar shape. The caulking part 40c is preferably bonded by welding to the negative electrode current collecting member 14.

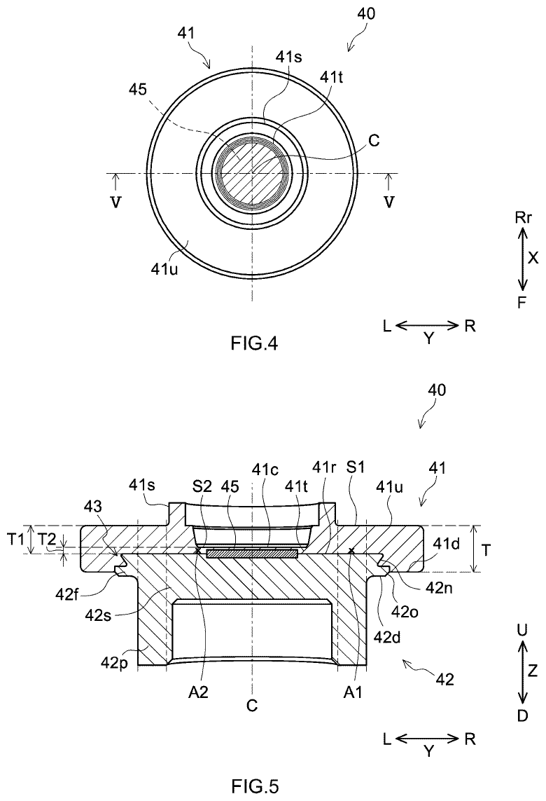

FIG. 4 is a schematic top view of the negative electrode terminal 40 before being attached to the lid body 24 (that is, before the caulking process). FIG. 5 is a schematic longitudinal cross-sectional view of the negative electrode terminal 40 in FIG. 4. As illustrated in FIG. 5, the negative electrode terminal 40 includes the first conductive member 41, the second conductive member 42, the fastening part 43, and the ultrasonic bonding part 45. The first conductive member 41 and the second conductive member 42 are electrically connected to each other through two kinds of coupling parts with different coupling methods, that is, the fastening part 43 and the ultrasonic bonding part 45. As a result, a state in which the first conductive member 41 and the second conductive member 42 are in close contact with each other can be suitably maintained easily. Thus, the conduction reliability of the negative electrode terminal 40 can be improved more suitably. However, the fastening part 43 is not essential and can be omitted in another embodiment.

The first conductive member 41 is a member disposed outside the battery case 20. The first conductive member 41 is formed of a first metal. The first conductive member 41 is formed of, for example, a conductive metal such as aluminum, an aluminum alloy, nickel, or stainless steel. The first conductive member 41 is preferably formed of aluminum or an aluminum alloy. The first conductive member 41 is formed of aluminum here. The first conductive member 41 is preferably formed of a metal with a smaller Vickers hardness (softer) than the second conductive member 42. The first conductive member 41 may be formed of the same metal as that of the positive electrode current collecting member 13, or may be formed of an alloy in which the same metal element constitutes a first component (i.e., the component with the highest content in a mass ratio; this similarly applies to the description below).

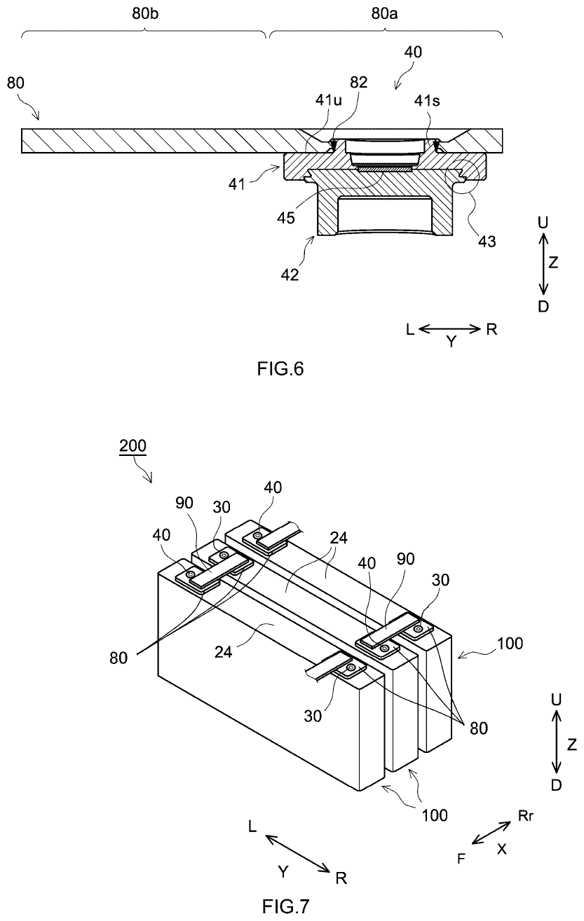

The first conductive member 41 has a circular shape (for example, perfect circular shape) here in the plan view as illustrated in FIG. 4. As illustrated in FIG. 5, the outer diameter of the first conductive member 41 is larger than that of the flange part 42f of the second conductive member 42 to be described below. The first conductive member 41 has an axis center C. The first conductive member 41 has a lower surface (first surface) 41d and an upper surface (second surface) 41u. The lower surface 41d is a surface on the side facing the battery case 20 (specifically, the lid body 24). The lower surface 41d is a surface in contact with the second conductive member 42. The upper surface 41u is a surface on the side opposite to the lower surface 41d in a thickness direction of the first conductive member 41 (a direction perpendicular to the lid body 24). The upper surface 41u is a surface on the side apart from battery case 20 and the second conductive member 42. The upper surface 41u is a surface to which an external conductive member 80 to be described below (see FIG. 6) is connected. Although not limited in particular, a thickness T of the first conductive member 41 (vertical distance from the upper surface 41u to the lower surface 41d) is preferably 0.5 to 5 mm and more preferably 1 to 3 mm.

As illustrated in FIG. 5, the first conductive member 41 includes a first concave part 41r, a second concave part 41c, a thin part 41t, and a rib 41s here. In another embodiment, however, the thin part 41t and/or the second concave part 41c may be absent in the first conductive member 41. Although the first conductive member 41 does not include a penetration hole here, the penetration hole may be provided additionally as described below in a second modification.

As illustrated in FIG. 5, the first concave part 41r is provided at the lower surface (first surface) 41d. The first concave part 41r is depressed from the lower surface 41d. The first concave part 41r is preferably formed axis-symmetrically about the axis center C of the first conductive member 41. Although the illustration is omitted, the first concave part 41r has a circular shape (for example, including a perfect circular shape and an approximately circular shape having a notch partially) in the plan view here. The first concave part 41r is formed to have a tapered shape with the diameter decreasing toward the lower surface 41d of the first conductive member 41 (in other words, as getting closer to the second conductive member 42) here. A part of the flange part 42f (specifically, constriction part 42n) of the second conductive member 42, which will be described below, is inserted into the first concave part 41r. The first concave part 41r is one example of the concave part of the first surface.

The second concave part 41c is provided at the upper surface (second surface) 41u. The second concave part 41c is depressed from the upper surface 41u. The second concave part 41c is preferably formed axis-symmetrically about the axis center C of the first conductive member 41. As illustrated in FIG. 4, the second concave part 41c has a circular shape (for example, perfect circular shape) in the plan view here. Although not limited in particular, as illustrated in FIG. 5, the outer diameter of the second concave part 41c (in a case of a perfect circle, a diameter, and in a case of a non-perfect circle, the minimum length passing a center) is smaller than the outer diameter of the first concave part 41r in the plan view here.

As illustrated in FIG. 4, the thin part 41t has a circular shape (for example, perfect circular shape) in the plan view here. As illustrated in FIG. 5, the thin part 41t is formed to be thinner than its outer peripheral part. That is to say, the thin part 41t has a thickness T2 that is smaller than the thickness T of the first conductive member 41. The thin part 41t is a region where the first concave part 41r and the second concave part 41c overlap with each other in the plan view here. It is preferable that the thin part 41t be provided in such a way that the second concave part 41c is formed on a surface (that is, upper surface 41u) on the side opposite to the lower surface 41d where the first concave part 41r is formed as described in this embodiment. In the thin part 41t, the ultrasonic bonding part 45 is provided. Thus, the energy at the bonding can be saved and the weldability can be improved. Additionally, the distortion or deformation of the first conductive member 41 at the ultrasonic bonding can be suppressed.

The first conductive member 41 includes a first region A1 and a second region A2, which are the regions sectioned in a radial direction over the first concave part 41r. The first region A1 is a region that overlaps with the tubular part 42p in a direction where the tubular part 42p of the second conductive member 42, which will be described below, extends (up-down direction Z in FIG. 5). The first region A1 is a region that overlaps with the tubular part 42p in the plan view here. In other words, the first region A1 is a region right above the tubular part 42p. The first region A1 has a ring shape (for example, annular shape) here. A first upper surface S1 of the first region A1 on the side opposite to the lower surface 41d protrudes in a direction (upward in FIG. 5) of separating from the lower surface 41d (or second conductive member 42) relative to a second upper surface S2 of the second region A2. The thickness T1 of the first region A1 is smaller than the thickness T of the first conductive member 41 because of the first concave part 41r, for example (that is, T1<T).

The second region A2 is a region that exists on an inner peripheral side relative to the first region A1 in the radial direction, and in the second region A2, the ultrasonic bonding part 45 is formed. The second region A2 corresponds to the thin part 41t here. The second region A2 is wider than the first region A1 in the radial direction (long side direction Y in FIG. 4). The second upper surface S2 (a bottom surface of the second concave part 41c) of the second region A2 on the side opposite to the lower surface 41d exists at a position lower than the first upper surface S1 of the first region A1 because of the second concave part 41c. It is preferable that the second region A2 do not protrude toward the upper surface 41u (upward in FIG. 4) relative to the first region A1. Thus, the energy at the bonding can be saved and the ultrasonic bonding part 45 can be stably formed easily in the second region A2. Additionally, the distortion or deformation of the first conductive member 41 at the ultrasonic bonding can be suppressed.

The thickness T2 of the second region A2 is smaller than the thickness T1 of the first region A1 because of the second concave part 41c (that is, T2<T1<T). The thickness T1 of the first region A1 and the thickness T2 of the second region A2 preferably satisfy T1/T2≤0.5 and more preferably T1/T2<0.5. Thus, the ultrasonic bonding part 45 can be formed in the second region A2 more stably. In the case where the thickness T2 of the second region A2 is small, the second region A2 is deformed easily or the ultrasonic bonding part 45 is damaged easily; thus, it is particularly effective to apply the art disclosed herein. However, the first upper surface S1 of the first region A1 and the second upper surface S2 of the second region A2 may alternatively be at the same height or at substantially the same height, which will be described below in the second modification.

The rib 41s protrudes from the upper surface (second surface) 41u. The rib 41s is provided on an outer peripheral side relative to the ultrasonic bonding part 45. The rib 41s is provided on the inner peripheral side relative to the fastening part 43. The rib 41s is provided between the first region A1 and the second region A2 in the radial direction. Since the rib 41s is provided between the first region A1 and the second region A2, the deformation of the second region A2 or the damage of the ultrasonic bonding part 45 in a manufacturing process to be described below (for example, caulking a terminal to a current collector or the like) can be suppressed. Therefore, the reliability of a connection part between the first conductive member 41 and the second conductive member 42 can be improved. The rib 41s may be provided at a position apart outward from an outer peripheral edge of the second concave part 41c.

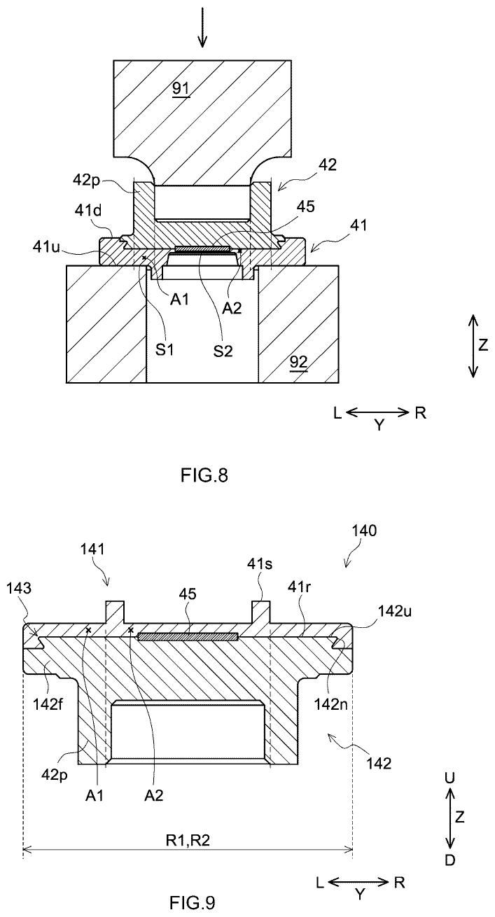

The rib 41s is preferably formed axis-symmetrically about the axis center C of the first conductive member 41. The rib 41s has a ring shape (for example, annular shape) here. The rib 41s is preferably provided in an annular shape so as to surround the second region A2. The rib 41s may be partially provided in the first region A1. The ratio of the formation area of the rib 41s to the area of the first region A1 is preferably less than 0.5 and more preferably less than 0.3. In a case of manufacturing an electrical energy storage module 200 (see FIG. 7) by electrically connecting the plurality of electrical energy storage devices 100 to each other, the external conductive member 80 (see FIG. 6) may be attached to the rib 41s, which will be described in detail below. For example, the external conductive member 80 may be metal-bonded (for example, bonded by welding) to the rib 41s.

The second conductive member 42 is a member extending from the inside to the outside of the battery case 20 through the terminal extraction hole 24h. The second conductive member 42 is formed of a second metal, which is different from the first metal. The second conductive member 42 is, for example, formed of a conductive metal such as copper, a copper alloy, nickel, or stainless steel. The second conductive member 42 is preferably formed of copper or a copper alloy. The second conductive member 42 is formed of copper here. The second conductive member 42 is preferably formed of a metal with a larger Vickers hardness (harder) than the first conductive member 41. The second conductive member 42 may be formed of the same metal as that of the negative electrode current collecting member 14, or an alloy having the same metal element as the first component. A metal-coated part coated with a metal such as Ni may be provided partially or entirely on the surface of the second conductive member 42.

The second conductive member 42 has the axis center C as illustrated in FIG. 5. The axis center C of the second conductive member 42 coincides with the axis center C of the first conductive member 41. Here, the second conductive member 42 includes the flange part 42f electrically connected to the first conductive member 41, the shaft part 42s coupled to the lower end part of the flange part 42f, and the tubular part 42p existing at an end part (lower end part) of the shaft part 42s on the side opposite to the side where the flange part 42f exists. The second conductive member 42 preferably includes the flange part 42f and the shaft part 42s coupled to one surface of the flange part 42f. The second conductive member 42 has a part that is disposed in the first concave part 41r of the first conductive member 41. At least a part of the flange part 42f of the second conductive member 42 is preferably disposed in the first concave part 41r of the first conductive member 41.

The flange part 42f has a larger outer shape than that of the shaft part 42s. The flange part 42f is a part protruding out of the battery case 20 through the terminal extraction hole 24h of the lid body 24. As illustrated in FIG. 3, the outer shape of the flange part 42f is larger than that of the terminal extraction hole 24h of the lid body 24. The outer shape of the flange part 42f is a substantially cylindrical columnar shape here. In the plan view, the flange part 42f preferably has a circular shape (for example, perfect circular shape). An axis center of the flange part 42f coincides with the axis center C of the second conductive member 42. In this embodiment, the flange part 42f includes the lower surface 42d, a side surface (outer peripheral surface) 420 extending upward from the lower surface 42d, and the constriction part 42n at which a part of the side surface 420 is constricted.

The constriction part 42n is provided continuously or intermittently in a part of the side surface 420 of the flange part 42f. The constriction part 42n is preferably fastened mechanically to the first conductive member 41 (for example, to an inner side surface of the first concave part 41r). Although the illustration is omitted, the constriction part 42n has a ring shape (for example, annular shape) in the plan view here. The constriction part 42n is formed axis-symmetrically about the axis center C of the flange part 42f. The constriction part 42n is formed to have an inverted-tapered shape with the diameter increasing toward the upper surface 41u (in other words, the diameter increasing with an increasing distance from the shaft part 42s). The constriction part 42n is inserted into the first concave part 41r of the first conductive member 41. The constriction part 42n is fitted into the first concave part 41r of the first conductive member 41, so as to be engaged with the first concave part 41r here. The constriction part 42n is an example of a part disposed in the concave part.

As illustrated in FIG. 5, the shaft part 42s extends downward from the lower end part of the flange part 42f. As illustrated in FIG. 3, the shaft part 42s is preferably inserted into the terminal extraction hole 24h of the lid body 24 at the time of attachment of the negative electrode terminal 40 to the lid body 24. Although the illustration is omitted, the outer shape of the shaft part 42s is a cylindrical shape here. The axis center of the shaft part 42s coincides with the axis center C of the second conductive member 42. The lower end part of the shaft part 42s, that is, the end part on the side opposite to the side where the flange part 42f exists is hollow before the caulking process. The lower end part of the shaft part 42s forms the tubular part 42p.

The tubular part 42p has a hollow cylindrical shape here. The tubular part 42p extends along the up-down direction Z. The tubular part 42p is disposed outside the first concave part 41r. The tubular part 42p is a part that is spread out by the caulking process when the negative electrode terminal 40 is attached to the lid body 24, thereby forming the caulking part 40c. The tubular part 42p is preferably electrically connected to the negative electrode current collecting member 14 inside the battery case 20 by the caulking process.

The fastening part 43 is a coupling part at which the first conductive member 41 and the second conductive member 42 are mechanically fastened to each other. By having the fastening part 43, the connection state between the first conductive member 41 and the second conductive member 42 can be stabilized more easily. The fastening part 43 is provided on the outer peripheral side relative to the ultrasonic bonding part 45. The fastening part 43 is provided on the outer peripheral side relative to the tubular part 42p. The fastening part 43 is provided on the outer peripheral side relative to the rib 41s. Here, the fastening part 43 is formed continuously. In the plan view, the fastening part 43 has a ring shape (for example, annular shape) here. As a result, it becomes possible to increase the strength of the fastening part 43 and to improve the conduction reliability of the negative electrode terminal 40.

The fastening part 43 is configured in such a way that a part of an inner wall of the first concave part 41r of the first conductive member 41 enters the constriction part 42n of the second conductive member 42 here. Thus, the inner wall of the first concave part 41r of the first conductive member 41 is fixed (for example, fixed by pressing) by the constriction part 42n of the second conductive member 42. It is preferable that the fastening part 43 be formed in such a way that the inner wall of the first concave part 41r of the first conductive member 41 and the side surface 420 of the flange part 42f of the second conductive member 42 are fastened. Accordingly, the strength of the fastening part 43 can be enhanced.

The method for forming the fastening part 43 is not particularly limited as long as mechanical bonding based on mechanical energy is used, and may be, for example, press-fitting, shrink-fitting, caulking, riveting, folding, bolt bonding, or the like. In some preferred embodiments, the fastening part 43 is preferably an engagement part at which the first concave part 41r of the first conductive member 41 and the constriction part 42n of the second conductive member 42 are engaged with each other. The fastening part 43 may be, for example, a press-fitting part in which the constriction part 42n of the second conductive member 42 is fitted by press-fitting (self-clinching) into the first concave part 41r of the first conductive member 41. Thus, the first conductive member 41 and the second conductive member 42 can be fixed suitably.

The ultrasonic bonding part 45 is a metal bonding part in which the first conductive member 41 and the second conductive member 42 are bonded to each other with ultrasonic waves. The ultrasonic bonding part 45 is provided in the second region A2. The ultrasonic bonding part 45 is provided on the inner peripheral side relative to the rib 41s. The ultrasonic bonding part 45 is provided on the inner peripheral side relative to the tubular part 42p. The ultrasonic bonding part 45 is provided in the thin part 41t here. The ultrasonic bonding part 45 is provided at a position apart from the fastening part 43 here. The ultrasonic bonding part 45 is provided on the inner peripheral side (central side) relative to the fastening part 43. The ultrasonic bonding part 45 can be a bonding part whose strength is lower (more fragile) than that of the fastening part 43. By arranging the ultrasonic bonding part 45 as above on the inner peripheral side of the fastening part 43, it becomes possible to stably maintain the ultrasonic bonding part 45, and to increase the conduction reliability of the negative electrode terminal 40 for a long time. Note that the ultrasonic bonding part 45 can be distinguished clearly from a part formed by, for example, laser welding or the like due to a pressing mark of a hone used in an ultrasonic bonding step to be described below.

The ultrasonic bonding part 45 is formed continuously or intermittently in the plan view. The ultrasonic bonding part 45 is preferably formed axis-symmetrically about the axis center C of the first conductive member 41 and the second conductive member 42 (for example, flange part 42f). In some preferred embodiments, the ultrasonic bonding part 45 has a circular shape (for example, perfect circular shape) in the plan view as illustrated in FIG. 4. As a result, it becomes possible to increase the strength of the ultrasonic bonding part 45 and to improve the conduction reliability of the negative electrode terminal 40. In addition, the area of the ultrasonic bonding part 45 can be enlarged, the conduction resistance can be reduced, and the resistance can be reduced. Furthermore, resistance heating can be suppressed and, for example, a thermal influence on a resin member such as the gasket 50 can be reduced.

In some preferred embodiments, the negative electrode terminal 40 further includes the external conductive member 80 (see FIG. 6). FIG. 6 is a longitudinal cross-sectional view illustrating schematically the connection between the negative electrode terminal 40 and the external conductive member 80. As illustrated in FIG. 6, the external conductive member 80 is attached to the rib 41s of the first conductive member 41 here. Specifically, the external conductive member 80 is metal-bonded (for example, bonded by welding) to the rib 41s. The external conductive member 80 is preferably formed of the same metal as that of the first conductive member 41, or an alloy having the same metal element as the first component. The external conductive member 80 is preferably formed of the first metal that forms the first conductive member 41. The external conductive member 80 is preferably formed of aluminum or an aluminum alloy. The external conductive member 80 is formed of aluminum here. The external conductive member 80 preferably has a plate shape (specifically, flat plate shape).

As can be seen from FIG. 7, the external conductive member 80 has an approximately rectangular shape having short sides and long sides in the plan view here. The external conductive member 80 is disposed so that the long side of the rectangular shape coincides with the long side direction Y of the lid body 24. The external conductive member 80 preferably extends along the long side direction Y of the lid body 24 as described in this embodiment.

As illustrated in FIG. 6, the external conductive member 80 includes regions sectioned into two in the long side direction Y: a connection part 80a electrically connected to the rib 41s and an extension part 80b extending from the connection part 80a to one side in the long side direction Y (leftward in FIG. 6).

In the connection part 80a, a welding bonding part 82 is provided at an outer peripheral edge of the rib 41s. The welding bonding part 82 is formed continuously or intermittently in the plan view. The welding bonding part 82 is provided continuously here. The welding bonding part 82 has a circular shape (for example, perfect circular shape). The welding bonding part 82 is preferably a laser welding part. According to the present inventors' examination, if the metal bonding part between the external conductive member 80 and the first conductive member 41 reaches the second conductive member 42, the metal bonding part may become fragile. When the external conductive member 80 is metal-bonded to the rib 41s, the reach of the metal bonding part between the external conductive member 80 and the first conductive member 41 at the second conductive member 42 can be suppressed and the decrease in reliability of the bonding part can be suppressed. Accordingly, the conduction reliability of the electrical energy storage module 200 can be increased. The external conductive member 80, however, does not always need to be attached to the rib 41s and may alternatively be attached to a place other than the rib 41s in another embodiment.

The extension part 80b is a part to which a bus bar 90 (see FIG. 7) is attached in a case where the electrical energy storage module 200 (see FIG. 7) is manufactured by electrically connecting the plurality of electrical energy storage devices 100 to each other. The provision of the extension part 80b can sufficiently secure the grounding surface area with the bus bar 90, and can improve the conduction reliability of the electrical energy storage module 200. In another embodiment, however, the bus bar 90 may be directly connected to the first conductive member 41 (for example, the upper surface 41u or the rib 41s) not through the external conductive member 80 (or the extension part 80b).

### <Manufacturing Method for Negative Electrode Terminal 40>

The negative electrode terminal 40 as described above can be manufactured suitably by, for example, a manufacturing method including a fastening step of preparing the first conductive member 41 and the second conductive member 42 and mechanically fastening the first conductive member 41 and the second conductive member 42 and an ultrasonic bonding step of bonding the first conductive member 41 and the second conductive member 42 to each other with ultrasonic waves in this order. By performing the bonding step after the fastening step, it becomes possible to prevent the damage of the ultrasonic bonding part 45 in the fastening step and form the ultrasonic bonding part 45 with the stable shape at high accuracy. However, the order of the fastening step and the bonding step may be opposite, or the steps may be performed substantially simultaneously. The manufacturing method disclosed herein may further include another step at any stage.

In the fastening step, the first conductive member 41 and the flange part 42f of the second conductive member 42 are mechanically fastened to each other, thereby forming the fastening part 43. The fastening part 43 can be formed by, for example, disposing the constriction part 42n of the second conductive member 42 in the first concave part 41r of the first conductive member 41, and deforming the first concave part 41r of the first conductive member 41 along the outer shape of the constriction part 42n of the second conductive member 42, thereby fixing the inner wall of the first concave part 41r with the second conductive member 42. Thus, the strength of the fastening part 43 can be improved. In some preferred embodiments, the fastening part 43 is formed by engaging (self-clinching) the first concave part 41r of the first conductive member 41 and the constriction part 42n of the second conductive member 42. For example, the fastening part 43 can be formed by horizontally press-fitting the constriction part 42n of the second conductive member 42 into the first concave part 41r of the first conductive member 41. The workability of the fastening step can be increased as a result.

In the ultrasonic bonding step, the ultrasonic bonding part 45 is formed in such a way that the second conductive member 42 is bonded with ultrasonic waves to the second region A2 of the first conductive member 41 while a part of the second conductive member 42 (for example, the flange part 42f) is disposed in the first concave part 41r of the first conductive member 41. The ultrasonic bonding part 45 is formed by bonding the second conductive member 42 to the thin part 41t with ultrasonic waves here. In the ultrasonic bonding, for example, ultrasonic vibration is applied while a hone is pressed against the second region A2 (specifically, the thin part 41t) of the first conductive member 41 so as to apply a pressing load thereto. Note that the method and conditions of the ultrasonic bonding may be similar to the conventional ones. A fragile intermetallic compound is formed at the bonding interface between the first conductive member 41 and the second conductive member 42 less easily in the ultrasonic bonding than in the laser welding, for example. Therefore, the metal bonding part with high strength can be formed stably. Moreover, since the second region A2 is formed of the thin part 41t in this embodiment, even if the first conductive member 41 is deformed in this step, the wall flow can escape suitably to the rib 41s. Accordingly, even if the first conductive member 41 does not include the penetration hole, for example, the occurrence of the unintended distortion or deformation in the first conductive member 41 can be suppressed.

### <Manufacturing Method for Electrical Energy Storage Device 100>

The electrical energy storage device 100 is characterized by using the positive electrode terminal 30 and/or the negative electrode terminal 40 as described above and the manufacturing process except the above point may be similar to the conventional one. The electrical energy storage device 100 can be manufactured in accordance with, for example, a manufacturing method that includes preparing the electrode body 10, the electrolyte, the case main body 22, the lid body 24, the positive electrode terminal 30, and the negative electrode terminal 40 as described above, and the manufacturing method includes a terminal attaching step and a case bonding step in this order.

In the terminal attaching step, the positive electrode terminal 30, the positive electrode current collecting member 13, the negative electrode terminal 40, and the negative electrode current collecting member 14 are attached to the lid body 24 and integrated. The negative electrode terminal 40 and the negative electrode current collecting member 14 are fixed to the lid body 24 by the caulking process (riveting) as illustrated in FIG. 3, for example. In some preferred embodiments, this step includes an inserting step and a caulking step in this order. Furthermore, another step may be included at an optional stage. For example, an external conductive member attaching step to be described below may be included after the caulking step.

In the inserting step, a part of the second conductive member 42 of the negative electrode terminal 40 is inserted into the hole part 14h of the negative electrode current collecting member 14. Specifically, the shaft part 42s before the caulking process is caused to sequentially pass, from above the lid body 24, through the cylindrical part 51 of the gasket 50, the terminal extraction hole 24h of the lid body 24, the hole part 60h of the insulator 60, and the hole part 14h of the negative electrode current collecting member 14. Thus, the tubular part 42p of the negative electrode terminal 40 protrudes downward from the hole part 14h of the negative electrode current collecting member 14.

In the caulking step, the second conductive member 42 of the negative electrode terminal 40 is caulked on the negative electrode current collecting member 14. Specifically, the tubular part 42p protruding from the hole part 14h of the negative electrode current collecting member 14 is caulked on the negative electrode current collecting member 14 so that a compression force is applied in the up-down direction Z. The caulking process is performed here in such a way that the gasket 50 is held between the negative electrode terminal 40 and the lid body 24 and moreover that the insulator 60 is held between the lid body 24 and the negative electrode current collecting member 14. The caulking part 40c is formed accordingly at a tip end part (lower end part in FIG. 3) of the shaft part 42s of the negative electrode terminal 40.

FIG. 8 is a longitudinal cross-sectional view illustrating schematically one example of this step. In FIG. 8, the illustration of the lid body 24, the gasket 50, the insulator 60, and the negative electrode current collecting member 14 is omitted. In some preferred embodiments, first, as illustrated in FIG. 8, a caulking apparatus including a punch (pressing jig) 91 and a die (receiving jig) 92 is prepared. The die 92 has a hollow tubular shape here, and at a central part, includes a hollow part whose inner diameter is larger than the outer diameter of the rib 41s of the first conductive member 41. Although not limited in particular, in this embodiment, the inner diameter of the die 92 satisfies ϕ=8.2 mm and the outer diameter thereof satisfies ϕ=15 mm or more. Next, the negative electrode terminal 40 is inverted in the up-down direction and disposed on a top surface of the die 92. This arrangement makes the upper surface 41u of the first conductive member 41, specifically the outer peripheral side relative to the rib 41s, face the die 92. The outer peripheral side of the upper surface 41u relative to the rib 41s is in contact with the die 92.

In this embodiment, the first conductive member 41 includes the second concave part 41c on the upper surface 41u. The first region A1 of the first conductive member 41 protrudes toward the upper surface 41u relative to the second region A2. In other words, in the first conductive member 41, the first upper surface S1 of the first region A1 (surface on the side opposite to the surface where the first concave part 41r is formed) protrudes in a direction (downward in FIG. 8) of separating from the lower surface 41d relative to the second upper surface S2 of the second region A2 (surface on the side opposite to the surface where the first concave part 41r is formed). At least a part of the first upper surface S1 (here, more than or equal to a half of the first upper surface S1) of the first region A1 is in contact with the die 92. On the other hand, the second upper surface S2 of the second region A2 where the ultrasonic bonding part 45 is formed floats from the die 92. The second conductive member 42 is not in contact with the die 92. Thus, the occurrence of the damage of the ultrasonic bonding part 45 can be suppressed more effectively.

Next, a tip end of the punch 91 is inserted into the tubular part 42p (hollow part) of the second conductive member 42 while the outer peripheral side relative to the rib 41s, specifically at least a part of the first upper surface S1 of the first region A1 is in contact with the die 92. As indicated by an arrow in FIG. 8, then, a compression force is applied in a direction where the tubular part 42p extends (a direction where the axis center C extends, here the up-down direction Z), so that the tubular part 42p is spread out and deformed by the tip end of the punch 91. Thus, the tubular part 42p is plastically deformed so as to embrace an outer edge part. As a result, the caulking part 40c is formed on the negative electrode current collecting member 14 and each component is fixed by caulking.

In this embodiment, the rib 41s is provided at a part of the first conductive member 41 that is between the first region A1 and the second region A2. Thus, the deformation of the second region A2 or the damage of the ultrasonic bonding part 45 provided in the second region A2 in this step can be suppressed effectively. Accordingly, the terminal with high reliability in the connection part between the first conductive member 41 and the second conductive member 42 is obtained. Note that in this embodiment, since the first conductive member 41 does not include the penetration hole, the area of the ultrasonic bonding part 45 can be enlarged, the conduction resistance can be reduced, and the resistance can be reduced. Additionally, the resistance heating can be suppressed and, for example, the thermal influence on the resin member such as the gasket 50 can be reduced.

Moreover, in this embodiment, the first region A1 protrudes toward the upper surface 41u relative to the second region A2. Thus, a lower part of the tubular part 42p can be received by the die 92, thereby making it easier to caulk the tubular part 42p. Since the second region A2 is depressed toward the lower surface 41d relative to the first region A1 (the second region A2 exists above the first region A1), it is difficult to apply the compression force of the caulking process in the region where the ultrasonic bonding part 45 is formed. Accordingly, the burden on the second region A2 or on the ultrasonic bonding part 45 provided in the second region A2 can be reduced at a higher level and the damage of the ultrasonic bonding part 45 can be suppressed more effectively.

As a result of such a caulking process, the base part 52 of the gasket 50 and the flat plate-shaped part of the insulator 60 are compressed, the gasket 50, the lid body 24, the insulator 60, and the negative electrode current collecting member 14 are fixed integrally to the lid body 24, and the terminal extraction hole 24h is sealed. The negative electrode current collecting member 14 is welded to the negative electrode current collector exposed part of the negative electrode current collector 12, and the negative electrode of the electrode body 10 and the negative electrode terminal 40 are electrically connected to each other. The attaching method for the positive electrode terminal 30 and the positive electrode current collecting member 13 may also be similar to that for the negative electrode terminal 40 and the negative electrode current collecting member 14 described above. The positive electrode current collecting member 13 is welded to the positive electrode current collector exposed part of the positive electrode current collector 11, and the positive electrode of the electrode body 10 and the positive electrode terminal 30 are electrically connected to each other. The lid body 24, the positive electrode terminal 30, the negative electrode terminal 40, and the electrode body 10 are integrated with each other accordingly.

In some embodiments, the caulking step is followed by the external conductive member attaching step of attaching (for example, bonding by welding) the external conductive member 80 to the negative electrode terminal 40. The external conductive member 80 is bonded by welding preferably after the caulking step. In this step, the external conductive member 80 is bonded by welding (for example, laser welding) to the rib 41s with an annular shape. Thus, for example, the welding bonding part 82 is formed in a peripheral part of the rib 41s of the first conductive member 41 and the external conductive member 80 is attached to the negative electrode terminal 40.

In the case bonding step, the electrode body 10 integrated with the lid body 24 is accommodated in an interior space of the case main body 22, and the lid body 24 is bonded by welding to a periphery of the opening part 22h of the case main body 22. The bonding by welding can be performed by a conventionally known method (for example, laser welding). Thus, the opening part 22h of the case main body 22 is sealed to integrate the case main body 22 and the lid body 24. After that, a nonaqueous electrolyte solution is injected through a liquid injection port, which is not illustrated, and the liquid injection port is covered, thereby sealing the electrical energy storage device 100. The electrical energy storage device 100 can be manufactured in the above-described manner.

### <Application of Electrical Energy Storage Device 100>

The electrical energy storage device 100 can be used in various applications and, for example, can be suitably utilized as a power source (driving power source) for motors mounted in various kinds of vehicles such as a passenger car and a truck. The vehicle is not limited to a particular type, and may be, for example, a plug-in hybrid electric vehicle (PHEV), a hybrid electric vehicle (HEV), or a battery electric vehicle (BEV). The electrical energy storage device 100 can suitably be used also as the electrical energy storage module 200 in which the plurality of electrical energy storage devices 100 are electrically connected to each other through the bus bars 90 (see FIG. 7).

FIG. 7 is a perspective view illustrating schematically the electrical energy storage module 200 according to one embodiment. As illustrated in FIG. 7, the electrical energy storage module 200 includes the plurality of electrical energy storage devices 100, and the bus bar 90 that electrically connects the first electrical energy storage device 100 and the second electrical energy storage device 100 to each other. The bus bar 90 is, for example, formed of a conductive metal such as aluminum, an aluminum alloy, nickel, or stainless steel. The bus bar 90 has a flat plate shape and here, is provided to link between the positive electrode terminal 30 of the first electrical energy storage device 100 and the negative electrode terminal 40 of the second electrical energy storage device 100 through the extension part 80b of the external conductive member 80. The bus bar 90 is preferably bonded by welding (for example, laser welding) to the external conductive member 80.

Although some embodiments of the present disclosure have been described above, the above-described embodiments are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed. For example, another modification can replace a part of the aforementioned embodiment or be added to the aforementioned embodiment. Additionally, the technical feature may be deleted as appropriate unless such a feature is described as an essential element.

(1) For example, in FIG. 4 in the embodiment described above, the first conductive member 41 has a circular shape in the plan view. However, the present disclosure is not limited to this example. The first conductive member 41 may have a rectangular shape with long sides and short sides and include an extension part as described in Japanese Patent Application Publication No. 2022-049729, for example. In this case, when the electrical energy storage module 200 is constructed, the bus bar 90 may be directly connected to the extension part of the first conductive member 41 not through the external conductive member 80.

(2) For example, in FIG. 5 in the embodiment described above, the constriction part 42n is provided at a part of the side surface 420 of the second conductive member 42. However, the present disclosure is not limited to this example. The constriction part 42n may be provided at a place other than the side surface 420, for example.

FIG. 9 is a view corresponding to FIG. 5 according to a first modification. As illustrated in FIG. 9, a negative electrode terminal 140 according to this modification includes a first conductive member 141, a second conductive member 142, a fastening part 143, and the ultrasonic bonding part 45. The first conductive member 141 may be similar to the first conductive member 41 except that the thin part 41t and the second concave part 41c are not provided and the whole is formed to be thinner than that in FIG. 5. The second conductive member 142 may be similar to the second conductive member 42 except that a constriction part 142n is provided on an upper surface 142u of a flange part 142f and the flange part 142f is formed to be thicker than that in FIG. 5. The fastening part 143 is an engagement part in which the first concave part 41r of the first conductive member 141 and the constriction part 142n provided on the upper surface 142u of the second conductive member 142 are engaged with each other.

In this modification, an outer diameter R1 of the first conductive member 141 and an outer diameter R2 of the flange part 142f of the second conductive member 142 are approximately the same. In this modification, the proportion of the second conductive member 142 is large in the region overlapping with the tubular part 42p (region compressed in the caulking step); therefore, particularly in the case where the Vickers hardness of the second conductive member 142 is higher than that of the first conductive member 141, the burden on the second region A2 or on the ultrasonic bonding part 45 provided in the second region A2 can be reduced at the higher level and the damage of the ultrasonic bonding part 45 can be suppressed more effectively.

(3) For example, in FIG. 5 in the embodiment described above, the first conductive member 41 does not include the penetration hole and the ultrasonic bonding part 45 is provided in the circular shape in the plan view. Moreover, the first upper surface S1 of the first region A1 protrudes in the thickness direction relative to the second upper surface S2 of the second region A2. However, the present disclosure is not limited to this example. The first conductive member 41 may include the penetration hole or the ultrasonic bonding part 45 may have an annular shape or the like in the plan view. The first upper surface S1 of the first region A1 and the second upper surface S2 of the second region A2 may have the same height or approximately the same height.

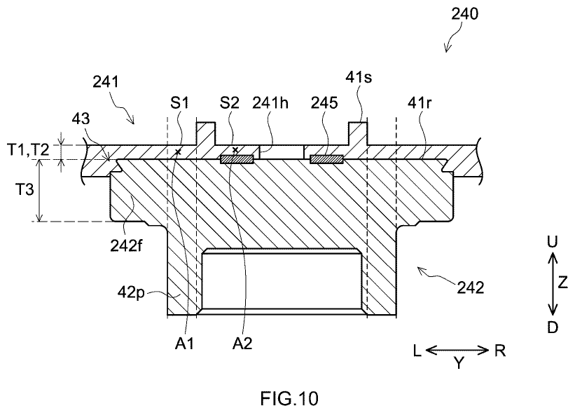

FIG. 10 is a view corresponding to FIG. 5 according to a second modification. As illustrated in FIG. 10, a negative electrode terminal 240 according to this modification includes a first conductive member 241, a second conductive member 242, the fastening part 43, and an ultrasonic bonding part 245. The first conductive member 241 may be similar to the first conductive member 41 except that a penetration hole 241h is provided and the whole is formed to be thinner than that in FIG. 5. The second conductive member 242 may be similar to the second conductive member 42 except that a flange part 242f is formed to be thicker than that in FIG. 5.

The penetration hole 241h penetrates the first conductive member 241 in the up-down direction Z. The penetration hole 241h is provided on the inner peripheral side (central side) relative to the fastening part 43 and the ultrasonic bonding part 245. The penetration hole 241h is provided at a central part of the second region A2. The penetration hole 241h has a circular shape (for example, perfect circular shape) in the plan view here. Although not limited in particular, the outer diameter of the penetration hole 241h (in a case of a perfect circle, a diameter, and in a case of a non-perfect circle, the minimum length passing a center) is preferably 5 to 7 mm, for example.

The ultrasonic bonding part 245 is formed continuously along a circumferential direction of the penetration hole 241h here. The ultrasonic bonding part 245 is provided around the penetration hole 241h. The ultrasonic bonding part 245 is provided at a position apart from the penetration hole 241h here. The ultrasonic bonding part 245 has a ring shape (for example, annular shape) in the plan view. The ultrasonic bonding part 245, however, may include a plurality of parts that are disposed at positions apart from each other.

In this modification, the first upper surface S1 of the first region A1 and the second upper surface S2 of the second region A2 may have the same height or approximately the same height. The thickness T1 of the first region A1 and the thickness T2 of the second region A2 are approximately the same (T1≅T2). The thickness T1 of the first region A1 and the thickness T2 of the second region A2 preferably satisfy 0.8≤T1/T2≤1.2 and more preferably satisfy 0.8<T1/T2<1.2. Since the rib 41s is provided between the first region A1 and the second region A2, even if T1 and T2 are approximately the same thickness, the burden on the second region A2 or on the ultrasonic bonding part 245 provided in the second region A2 can be reduced at the higher level and the damage of the ultrasonic bonding part 245 can be suppressed effectively in the caulking process. This modification is particularly preferable when the thickness T1 of the first region A1 is small (for example, T1 is 1.5 mm or less or 0.8 mm or less). The thickness T1 of the first region A1 is preferably 0.1 mm or more. The thickness T2 of the second region A2 is preferably 2.0 mm or less and more preferably 0.6 mm or less, for example. The thickness T2 of the second region A2 is preferably 0.1 mm or more.

In this modification, a thickness (maximum thickness) T3 of the flange part 242f and the thickness T1 of the first region A1 preferably satisfy 3≤T3/T1. When the thickness of the flange part 242f is larger than the thickness T1 of the first region A1, the occurrence of the unintended deformation can be suppressed in the caulking process of the tubular part 42p to be described below. In addition, the application of the burden on the ultrasonic bonding part 245 can be suppressed.

(4) For example, in the aforementioned embodiment, the tubular part 42p of the negative electrode terminal 40 is deformed and caulked, so that the negative electrode terminal 40 is fixed on the negative electrode current collecting member 14, and the negative electrode terminal 40 and the negative electrode current collecting member 14 are electrically connected to each other. However, the present disclosure is not limited to this example. The method for electrically connecting the negative electrode current collecting member 14 and the negative electrode terminal 40 may be, for example, mechanical fixing other than the caulking process, may be metal bonding typified by welding, or may be a combination of the foregoing.

As described above, the following items are given as specific aspects of the art disclosed herein.

Item 1: The terminal for the electrical energy storage device, including: the first conductive member that is formed of the first metal and includes the concave part on the first surface; the second conductive member that is formed of the second metal, which is different from the first metal, and includes the part disposed in the concave part; and the ultrasonic bonding part where the first conductive member and the second conductive member are bonded to each other with ultrasonic waves, in which the first conductive member includes the rib that is provided on the outer peripheral side relative to the ultrasonic bonding part and that protrudes from the second surface of the first conductive member that is on the side opposite to the first surface.

Item 2: The terminal according to Item 1, in which the second conductive member includes the hollow tubular part, and when the region of the first conductive member that overlaps with the tubular part in the direction where the tubular part extends is the first region and the region thereof that exists on the inner side relative to the first region and includes the ultrasonic bonding part is the second region, the rib is provided between the first region and the second region.

Item 3: The terminal according to Item 2, in which the second region does not protrude toward the second surface relative to the first region.

Item 4: The terminal according to Item 2 or 3, in which the thickness T1 of the first region and the thickness T2 of the second region satisfy 0.8≤T1/T2≤1.2.

Item 5: The terminal according to any one of Items 2 to 4, in which the second conductive member is formed of copper or a copper alloy and includes the flange part, at least a part of the flange part is disposed in the concave part of the first conductive member, and the thickness T3 of the flange part and the thickness T1 of the first region satisfy 3≤T3/T1.

Item 6: The terminal according to Item 2 or 3, in which the thickness T1 of the first region and the thickness T2 of the second region satisfy T1/T2≤0.5.

Item 7: The terminal according to any one of Items 1 to 6, further including the fastening part where the first conductive member and the second conductive member are mechanically fastened on the outer peripheral side relative to the ultrasonic bonding part.

Item 8: The terminal according to any one of Items 1 to 7, further including the external conductive member that is bonded by welding to the rib of the first conductive member.

Item 9: The manufacturing method for the electrical energy storage device including: the electrode body that includes the first electrode and the second electrode whose polarity is different from the polarity of the first electrode; the battery case that accommodates the electrode body; the terminal that is electrically connected to the first electrode and attached to the battery case; and the current collecting member that includes the hole part and electrically connects the first electrode and the terminal inside the battery case, in which the terminal includes: the first conductive member that is formed of the first metal and includes the concave part on the first surface; the second conductive member that is formed of the second metal, which is different from the first metal, and includes the part disposed in the concave part; and the ultrasonic bonding part where the first conductive member and the second conductive member are bonded to each other with ultrasonic waves, in which the first conductive member includes the rib that is provided on the outer peripheral side relative to the ultrasonic bonding part and that protrudes from the second surface of the first conductive member that is on the side opposite to the first surface, and the manufacturing method includes: the inserting step of inserting a part of the second conductive member of the terminal into the hole part of the current collecting member; and the caulking step of caulking a part of the second conductive member on the current collecting member while the receiving jig is in contact with the outer peripheral side of the terminal relative to the rib after the inserting step.

Item 10: The manufacturing method according to Item 9, in which in the inserting step, the terminal includes the ultrasonic bonding part between the first conductive member and the second conductive member.

Item 11: The manufacturing method according to Item 9 or 10, in which the second conductive member of the terminal includes the hollow tubular part, when the region of the first conductive member that overlaps with the tubular part in the direction where the tubular part extends is the first region and the region thereof that exists on the inner side relative to the first region and includes the ultrasonic bonding part is the second region, the second region does not protrude toward the second surface relative to the first region, and in the caulking step, the tubular part of the second conductive member is caulked on the current collecting member while the receiving jig is in contact with the side of the second surface of the first region.

Item 12: The manufacturing method according to Item 11, in which in the terminal, the thickness T1 of the first region and the thickness T2 of the second region satisfy 0.8≤T1/T2≤1.2.

Item 13: The manufacturing method according to Item 11 or 12, in which the second conductive member of the terminal is formed of copper or a copper alloy and includes the flange part, at least a part of the flange part is disposed in the concave part of the first conductive member, and the thickness T3 of the flange part and the thickness T1 of the first region satisfy 3≤T3/T1.

Item 14: The manufacturing method according to Item 11, in which in the terminal, the thickness T1 of the first region and the thickness T2 of the second region satisfy T1/T2≤0.5.

Item 15: The manufacturing method according to any one of Items 9 to 14, in which the terminal further includes the fastening part where the first conductive member and the second conductive member are mechanically fastened on the outer peripheral side relative to the ultrasonic bonding part.

Item 16: The manufacturing method according to any one of Items 9 to 15, in which the terminal further includes the external conductive member, and the manufacturing method further includes the external conductive member attaching step of bonding the external conductive member by welding to the rib after the caulking step.

### REFERENCE SIGNS LIST

10 Electrode body
14 Negative electrode current collecting member (current collecting member)
20 Battery case
24 Lid body
40, 140, 240 Negative electrode terminal (terminal)
40c Caulking part
41, 141, 241 First conductive member
41d Lower surface (first surface)
41r First concave part
41t Thin part
41s Rib
42, 142, 242 Second conductive member
42f, 142f Flange part
42n Constriction part (part disposed in concave part)
42p Tubular part
43, 143 Fastening part
45, 245 Ultrasonic bonding part
100 Electrical energy storage device
200 Electrical energy storage module

What is claimed is:

1. A terminal for an electrical energy storage device, comprising:
a first conductive member that is formed of a first metal and includes a concave part on a first surface;
a second conductive member that is formed of a second metal, which is different from the first metal, and includes a part disposed in the concave part; and
an ultrasonic bonding part where the first conductive member and the second conductive member are bonded to each other with ultrasonic waves, wherein the first conductive member includes a rib that is provided on an outer peripheral side relative to the ultrasonic bonding part and that protrudes from a second surface of the first conductive member that is on a side opposite to the first surface.

2. The terminal according to claim 1, wherein
the second conductive member includes a hollow tubular part, and
when a region of the first conductive member that overlaps with the tubular part in a direction where the tubular part extends is a first region and a region thereof that exists on an inner side relative to the first region and includes the ultrasonic bonding part is a second region, the rib is provided between the first region and the second region.

3. The terminal according to claim 2, wherein the second region does not protrude toward the second surface relative to the first region.

4. The terminal according to claim 2, wherein a thickness T1 of the first region and a thickness T2 of the second region satisfy 0.8≤T1/T2≤1.2.

5. The terminal according to claim 2, wherein
the second conductive member is formed of copper or a copper alloy and includes a flange part,
at least a part of the flange part is disposed in the concave part of the first conductive member, and
a thickness T3 of the flange part and a thickness T1 of the first region satisfy 3≤T3/T1.

6. The terminal according to claim 2, wherein a thickness T1 of the first region and a thickness T2 of the second region satisfy T1/T2≤0.5.

7. The terminal according to claim 1, further comprising a fastening part where the first conductive member and the second conductive member are mechanically fastened on the outer peripheral side relative to the ultrasonic bonding part.

8. The terminal according to claim 1, further comprising an external conductive member that is bonded by welding to the rib of the first conductive member.

9. A manufacturing method for an electrical energy storage device including:
an electrode body that includes a first electrode and a second electrode whose polarity is different from a polarity of the first electrode;
a battery case that accommodates the electrode body;
a terminal that is electrically connected to the first electrode and attached to the battery case; and
a current collecting member that includes a hole part and electrically connects the first electrode and the terminal inside the battery case, wherein
the terminal includes:
a first conductive member that is formed of a first metal and includes a concave part on a first surface;
a second conductive member that is formed of a second metal, which is different from the first metal, and includes a part disposed in the concave part; and
an ultrasonic bonding part where the first conductive member and the second conductive member are bonded to each other with ultrasonic waves, wherein the first conductive member includes a rib that is provided on an outer peripheral side relative to the ultrasonic bonding part and that protrudes from a second surface of the first conductive member that is on a side opposite to the first surface, and
the manufacturing method comprises:
an inserting step of inserting a part of the second conductive member of the terminal into the hole part of the current collecting member; and
a caulking step of caulking a part of the second conductive member on the current collecting member while a receiving jig is in contact with an outer peripheral side of the terminal relative to the rib after the inserting step.

10. The manufacturing method for the electrical energy storage device according to claim 9, wherein in the inserting step, the terminal includes the ultrasonic bonding part between the first conductive member and the second conductive member.

11. The manufacturing method according to claim 9, wherein
the second conductive member of the terminal includes a hollow tubular part,
when a region of the first conductive member that overlaps with the tubular part in a direction where the tubular part extends is a first region and a region thereof that exists on an inner side relative to the first region and includes the ultrasonic bonding part is a second region, the second region does not protrude toward the second surface relative to the first region, and
in the caulking step, the tubular part of the second conductive member is caulked on the current collecting member while the receiving jig is in contact with a side of the second surface of the first region.

12. The manufacturing method according to claim 11, wherein in the terminal, a thickness T1 of the first region and a thickness T2 of the second region satisfy 0.8≤T1/T2≤1.2.

13. The manufacturing method according to claim 11, wherein
the second conductive member of the terminal is formed of copper or a copper alloy and includes a flange part,
at least a part of the flange part is disposed in the concave part of the first conductive member, and
a thickness T3 of the flange part and a thickness T1 of the first region satisfy 3≤T3/T1.

14. The manufacturing method according to claim 11, wherein in the terminal, a thickness T1 of the first region and a thickness T2 of the second region satisfy T1/T2≤0.5.

15. The manufacturing method according to claim 9, wherein the terminal further includes a fastening part where the first conductive member and the second conductive member are mechanically fastened on the outer peripheral side relative to the ultrasonic bonding part.

16. The manufacturing method according to claim 9, wherein
the terminal further includes an external conductive member, and
the manufacturing method further includes an external conductive member attaching step of bonding the external conductive member by welding to the rib after the caulking step.
